(19) United States
(12) Patent Application Publication
(10) Pub. No.: US 2006/0146125 A1
(43) Pub. Date: Jul. 6, 2006

(54) Virtual retinal display generating principal virtual image of object and auxiliary virtual image for additional function

(75) Inventor: Shoji Yamada, Konan-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/368,378

(22) Filed: Mar. 7, 2006

Related U.S. Application Data
(63) Continuation of application No. PCT/JP04/10606, filed on Jul. 26, 2004.

(30) Foreign Application Priority Data
Sep. 11, 2003 (JP) 2003-319274

(51) Int. Cl. H04N 13/04; H04N 15/00

(52) U.S. Cl. 348/51

(57) ABSTRACT

An apparatus for projecting modulated light onto a retina of a viewer, to thereby allow the viewer to perceive a display object via a virtual image is disclosed. The apparatus is configured to include: an emitter emitting light; a modulator modulating the light; and a controller controlling the emitter and the modulator for generating virtual images to be perceived by the viewer in an image display field. The controller is operated, such that a principal virtual image defining the display object is perceived by the viewer in a principal display region of the image display field, and such that an auxiliary virtual image is perceived by the viewer together with the principal virtual image, in an auxiliary display region which is located in the image display field in a predetermined positional relationship with the principal display region, as viewed from the viewer.

### CROSS-REFERENCE TO RELATED APPLICATIONS

This application is based on Japanese Patent Application No. 2003-319274 filed Sep. 11, 2003, and PCT International Application No. PCT/JP2004/010606 filed Jul. 26, 2004, the contents of which are incorporated hereinto by reference.

This is a continuation of International Application No. PCT/JP2004/010606 filed Jul. 26, 2004, which was published in Japanese under PCT Article 21(2).

### BACKGROUND OF THE INVENTION

1. Field of the Invention

The invention relates to techniques of projecting modulated light onto the retina of a viewer, to thereby allow the viewer to perceive a display object via a virtual image, and more particularly to improved techniques of generating virtual images.

2. Description of the Related Art

There are known apparatuses for use in the display of an image with a wider field of view in spite of these apparatuses' compactness. The apparatuses each are configured to project modulated light onto the retina of a viewer, to thereby allow the viewer to perceive a display object or a visual content via a virtual image.

As one of types of such apparatuses, there is known an apparatus, which may be referred to as “on-screen light emission type display apparatus,” which employs a physical display screen as a surface-illuminant, and in which light from the display screen enters the pupil of a viewer after passing through a magnifier such as a convex lens. See, for example, Japanese Patent Application Publication No. HEI 7-38825.

As an alternative type of such apparatuses, there is known a retinal scanning display in which a beam of light is projected onto the retina of a viewer while being scanned on the retina. See, for example, Japanese Patent No. 2874208.

This retinal scanning display or virtual retinal display is categorized in type into a device allowing a viewer to perceive a two- or three-dimensional object in the form of a two-dimensional image using a two-dimensional virtual image, and a device allowing a viewer to perceive a three-dimensional object in the form of a three-dimensional image using a three-dimensional virtual image.

Any one of kinds of the above-described apparatuses for displaying images is classified into an enclosed type (i.e., immersive type) allowing a viewer to perceive a virtual image within a light occluding enclosure, and a see-through type allowing a viewer to perceive a virtual image overlaid onto a background which is a real world view of the ambient environment.

In the latter see-through display, the ambient light output from the real world scene enters the eye of a viewer, as opposed to the former enclosed display.

### BRIEF SUMMARY OF THE INVENTION

For any one of the above types, an apparatus for displaying an image is required to reduce fatigue of a viewer while perceiving a display object, and to achieve stable perception by the viewer of the display object. What is important for satisfying such requirements is to allow the viewer to perceive or interpret an absolute size of the display object and a distance of the display object image from the viewer, as correctly as possible, through a corresponding virtual image.

The employment of a conventional image display of enclosed type described above, however, causes a viewer to perceive a virtual image solely, without allowing the viewer to rely on a real world scene which contains a real existence separate from the virtual image. The real existence can be a clue or a cue (i.e., a visual presentation) which can promote true perception by the viewer of the absolute size of the display object (i.e., its virtual image) and the distance of the display object (i.e., its virtual image) from the viewer.

For this reason, the viewer, when using this conventional enclosed display, finds it relatively difficult to precisely interpret the absolute size of the display object and the distance of the display object from the viewer.

In contrast, the employment of an image display apparatus of see-through type also described above allows a viewer to perceive a virtual image in combination with a real world scene which can contain a real existence separate from the virtual image. Viewing the real existence allows the viewer to easily interpret the absolute size of the real existence and the distance of the real existence from the viewer.

It follows that this conventional see-through display enables a viewer to perceive a virtual image in direct comparison with a separate real existence, and therefore this makes it relatively easy for the viewer to interpret correctly the absolute size of the display object and the distance of the display object from the viewer.

The viewer, even when using this conventional see-through display, however, fails to correctly compare a virtual image and a separate real existence with each other, unless the virtual image and an image of the separate real existence are located adequately close to each other, as viewed from a viewer. The viewer therefore finds it relatively difficult to precisely perceive the absolute size of the display object and the distance of the display object from the viewer.

To summarize the above discussion, a conventional image display, whether or not it is of an enclosed or see-through type, makes it relatively difficult for a viewer to correctly perceive the absolute size of a display object and the distance of the display object from the viewer, resulting in failure of stable perception by the viewer.

In contrast to the conventional techniques described above, Japanese Patent Application Publication No. HEI 7-38825 referenced above sets forth, as an example of an image displaying apparatus of see-through type, an on-screen light emission type image display in which the surface of a liquid crystal display panel is employed as a light-emission screen.

Upon activation of this image display, there are combined a principal real image of a display object and a special pattern. The principal real image is produced in a display field on the liquid crystal display panel, while the special pattern is produced and displayed in a peripheral display region which is disposed outside and around the display field of the liquid crystal display panel.

In this image display, the special pattern is produced, so that the perception provided to the viewer through the principal image concerning the distance of the principal real image from the viewer and the size of the principal real image may reflect precisely the reality of the display object.

What Publication No. HEI 7-38825 referenced above describes more specifically is that the above special pattern is displayed or visualized without using the liquid crystal display panel. That is to say, this publication describes that the liquid crystal display panel which functions as a light emitter is used only for displaying the principal real image, and that the special pattern is displayed or visualized via a device separate from the liquid crystal display panel.

Further, this publication describes that the special pattern is displayed on a plane which is optically coincident with an image plane of the liquid crystal display panel, and that the entirety of the special pattern is neither altered with changes in the display position of the principal image, nor altered with changes in the absolute size of the principal image. The special pattern lies in a non-movable flat plane, resulting in limited effect of the special pattern for promoting the viewer's distance or depth perception.

The techniques disclosed in this publication, even though it employs the special pattern, make it difficult to improve adequately the reality of what the viewer perceives through the principal image.

In addition, the see-through display disclosed in Publication No. HEI 7-38825 referenced above is used combined with a light occluding element as a real existence which inhibits entry of ambient light from a real world scene into the eye of a viewer through a displayed virtual image, for avoiding the ambient light from affecting the virtual image perceived by the viewer. That is to say, the perceived virtual image appears to be solid, not to be transparent.

The employment of the above light occluding element, in spite of this display being of see-through type, enables the viewer to stably perceive a display object via its virtual image in a local region within the field of view in which the virtual image is perceived by the viewer, because of the absence of any superposition between the virtual image and the real world scene.

When this see-through display is operated, the above light occluding element and the perceived virtual image are however not always coincident with each other concerning the distance from the viewer, and rather, they are normally different in the distance from each other.

For this reason, this see-through display causes the viewer, when attempting to focus on the displayed virtual image, to see a marginal portion, in particular, of the above light occluding element, as a fuzzy, out of focus image.

As a result, the viewer perceives just as if a physical obstacle were located at the light occluding element (far in front of the displayed image, for example), causing the viewer's unnaturalism (unnatural impression) and faster fatigue in the eye of the viewer.

It is therefore an object of the present invention to provide image display techniques in which modulated light is projected onto the retina of a viewer, to thereby allow the viewer to perceive a display object via a virtual image, and which have improvements in the technique of generating virtual images.

According to a first aspect of the present invention, there is provided an apparatus for projecting modulated light onto a retina of a viewer, to thereby allow the viewer to perceive a display object via a virtual image.

This apparatus comprises:

an emitter emitting light;

a modulator modulating the light; and

a controller controlling the emitter and the modulator for generating virtual images to be perceived by the viewer in an image display field, such that a principal virtual image defining the display object is perceived by the viewer in a principal display region of the image display field, and such that an auxiliary virtual image is perceived by the viewer together with the principal virtual image, in an auxiliary display region which is located in the image display field in a predetermined positional relationship with the principal display region, as viewed from the viewer.

In a preferred embodiment of this apparatus, the controller includes a cueing block cueing the viewer with the auxiliary virtual image, to promote perception by the viewer of at least one attribute of the display object. The at least one attribute is defined to include at least one of an absolute size of the display object and a distance of the display object from the viewer.

According to a second aspect of the present invention, there is provided a method of projecting modulated light onto a retina of a viewer, to thereby allow the viewer to perceive a display object via a virtual image.

This method comprises the steps of:

generating a principal virtual image defining the display object, to be perceived by the viewer in a principal display region of an image display field; and

generating an auxiliary virtual image to be perceived by the viewer in an auxiliary display region which is located in the image display field in a predetermined positional relationship with the principal display region, as viewed from the viewer.

In a preferred embodiment of this method, the step of displaying the auxiliary virtual image includes a step of cueing the viewer with the auxiliary virtual image, to promote perception by the viewer of at least one attribute of the display object. The at least one attribute is defined to include at least one of an absolute size of the display object and a distance of the display object from the viewer.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings For the purpose of illustrating the invention, there are shown in the drawings embodiments which are presently preferred. It should be understood, however, that the invention is not limited to the precise arrangements and instrumentalities shown. In the drawings:

FIG. 1 is a diagram schematically illustrating the interior construction of a retinal-scanning-type display device according to a first embodiment of the present invention;

FIG. 2 is a side view for explaining how a principal virtual image 16 and an auxiliary virtual image 17 are perceived by a viewer with the retinal-scanning-type display device shown in FIG. 1;

FIG. 3 is a front view illustrating the principal virtual image 16 and the auxiliary virtual image 17 shown in FIG. 2 in a viewing direction of the viewer;

FIG. 4 is a block diagram schematically illustrating the hardware construction of a signal processing circuit 60 shown in FIG. 1;

FIG. 5 is a flow chart schematically illustrating an image display program shown in FIG. 4;

FIG. 6 is a front view for explaining how the principal virtual image 16 and an auxiliary virtual image 190 are perceived by a viewer with a retinal-scanning-type display device according to a second embodiment of the present invention;

FIG. 7 is a flow chart schematically illustrating an image display program executed by a computer 160 of a retinal-scanning-type display device according to a third embodiment of the present invention;

FIG. 8 is a side view for explaining how the principal virtual image 16 and the auxiliary virtual image 17 are perceived by a viewer with a retinal-scanning-type display device according to a fourth embodiment of the present invention;

FIG. 9 is a front view illustrating the principal virtual image 16 and the auxiliary virtual image 17 shown in FIG. 8 in a viewing direction of the viewer;

FIG. 10 is a side view for explaining how the principal virtual image 16 and an virtual edge frame 230 are perceived by a viewer with a retinal-scanning-type display device according to a fifth embodiment of the present invention; and

FIG. 11 is a front view illustrating the principal virtual image 16 and the virtual edge frame 230 shown in FIG. 10 in a viewing direction of the viewer.

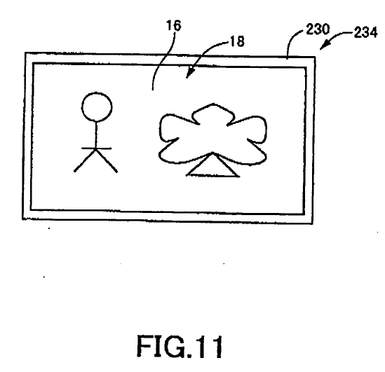

### DETAILED DESCRIPTION OF THE INVENTION

The object mentioned above may be achieved according to any one of the following modes of this invention.

These modes will be stated below so as to be blocked and numbered, and so as to depend upon the other mode or modes, where appropriate. This is for a better understanding of some of a plurality of technological features and a plurality of combinations thereof disclosed in this description, and does not mean that the scope of these features and combinations is interpreted to be limited to the scope of the following modes of this invention.

That is to say, it should be interpreted that it is allowable to select the technological features which are stated in this description but which are not stated in the following modes, as the technological features of this invention.

Furthermore, stating each one of the modes of the invention in such a dependent form as to depend from the other mode or modes does not exclude the possibility that the technological features set forth in a dependent-form mode become independent of those set forth in the corresponding depended mode or modes and to be removed therefrom. It should be interpreted that the technological features set forth in a dependent-form mode is allowed to become independent, where appropriate.

(1) An apparatus for projecting modulated light onto a retina of a viewer, to thereby allow the viewer to perceive a display object via a virtual image, the apparatus comprising:

an emitter emitting light;

a modulator modulating the light; and

a controller controlling the emitter and the modulator for generating virtual images to be perceived by the viewer in an image display field, such that a principal virtual image defining the display object is perceived by the viewer in a principal display region of the image display field, and such that an auxiliary virtual image is perceived by the viewer together with the principal virtual image, in an auxiliary display region which is located in the image display field in a predetermined positional relationship with the principal display region, as viewed from the viewer.

The apparatus according to the above mode (1) is configured such that virtual images include the principal virtual image and the auxiliary virtual image, and such that the image display field, in which these virtual images are perceived by the viewer, includes the principal display region and the auxiliary display region.

In operation of this apparatus, the display object is perceived by the viewer in the form of the principal virtual image in the principal display region, and in addition to that, an auxiliary object is perceived by the viewer in the form of the auxiliary virtual image in the auxiliary display region.

Further, in operation of this apparatus, both the principal and auxiliary virtual images are generated using the same emitter. This apparatus therefore does not require different emitters for generating two different virtual images, namely, the principal and auxiliary virtual images, resulting in easier simplification in system configuration and easier reduction in the part count of this apparatus.

The apparatus according to the above mode (1) may be embodied in an arrangement allowing both the principal and auxiliary virtual images to be generated using modulated light. This arrangement may be practiced such that the same modulator is employed for the generation of both the principal and auxiliary virtual images. Hence, this arrangement does not require different modulators for generating two different virtual images, namely, the principal and auxiliary virtual images, resulting in easier simplification in system configuration and easier reduction in the part count of this apparatus.

The “apparatus” according to the above mode (1) may be embodied as an on-screen light emission type display device or a retinal scanning type display device, each described above, for example.

The retinal scanning type display device means to include a device allowing a viewer to perceive a 2- or three-dimensional object in the form of a two-dimensional image using a two-dimensional virtual image, and a device allowing a viewer to perceive a three-dimensional object in the form of a three-dimensional image using a three-dimensional virtual image, as described above.

The “principal virtual image” set forth in the above mode (1) may be formed as a two-dimensional virtual image, or a three-dimensional virtual image. Likewise, the “auxiliary virtual image” set forth in the same mode may be formed as a two-dimensional virtual image, or a three-dimensional virtual image.

In this context, the term “two-dimensional virtual image” is used to mean that all points on a virtual image are located at substantially the same distance from a viewer. Accordingly, for example, a parallax image for a viewer's right and left eyes lying in a single flat plane, while providing artificial stereoscopy to a viewer, falls within this “two-dimensional virtual image.”

In contrast, the “three-dimensional virtual image” is used to mean that not all points on a virtual image are located at the same distance from a viewer. For example, if parallax is provided to the viewer concerning the respective points in the virtual image so as to change with changes in the corresponding respective distances of the points from the viewer, then the viewer's perception of stereoscopy and depth becomes identical to that perceived in the viewer's real viewing.

The “principal display region” set forth in the above mode (1) may be virtually located at a distance from the viewer which allows the viewer to perceive the same distance as a distance between the display object and the viewer, for example.

In addition, the “apparatus” according to the above mode (1) may be of an enclosed type or of a see-through type, for example.

The “emitter” set forth in the above mode (1) may be of a type using a natural light source, or a type using an artificial light source, for example. Further, the “emitter” may be of a type using a primary light source which is illuminant, or a type using a secondary light source acting, upon reception of light from the primary light source, as if it were an illuminant, for example.

The “auxiliary virtual image” set forth in the above mode (1) may be, for example, a reference virtual image to be referred to by the viewer, while viewing the principal virtual image, for promoting the reality of the principal virtual image.

Alternatively or additionally, the “auxiliary virtual image” set forth in the above mode (1) may be an additional virtual image to be perceived by the viewer, while viewing the principal virtual image, for visually clearly separating the display region of the principal virtual image and the display region of the auxiliary virtual image from each other.

A preferred example of such an additional virtual image may be a virtual edge frame which is perceived by the viewer, around the periphery of the perceived principal virtual image.

Further, the “auxiliary virtual image” set forth in the above mode (1) may be defined, for example, to be in common to the “principal virtual image” in that both are virtual images, and to be distinguishable from the principal virtual image” in that the auxiliary virtual image is intended for promoting a viewer's perception of the distance and size of the “principal virtual image,” wherein the principal virtual image is intended for presenting to the viewer the content and express or implied meaning of the display object.

Still further, the “emitter” and the “modulator” set forth in the above mode (1) may be formed physically separately from each other or physically integrally with each other. For example, the “emitter” may be formed to have not only a light emitting function but also a light modulating function.

(2) The apparatus according to mode (1), wherein the controller includes a perception promoter, or a cueing block cueing the viewer with the auxiliary virtual image, to promote perception by the viewer of at least one attribute of the display object, the at least one attribute being defined to include at least one of an absolute size of the display object and a distance of the display object from the viewer.

The apparatus according to the above mode (2) allows the viewer to perceive the principal virtual image while referring to the auxiliary virtual image, resulting in the presentation of the visual information of the auxiliary virtual image to the viewer as the viewer's motivation for correct correlation of a relevant piece of the viewer's knowledge with the principal virtual image. This helps the viewer to correctly perceive at least one of an absolute size of the display object and a distance of the display object from the viewer.

In this regard, the auxiliary virtual image functions as an artificial depth cue for the principal virtual image which is located independently of the auxiliary virtual image.

Therefore, the apparatus according to the above mode (2) promotes the viewer to correctly perceive at least one of the absolute size of the principal virtual image (i.e., the display object) and the distance of the principal virtual image (i.e., the display object) from the viewer.

(3) The apparatus according to mode (1) or (2), wherein the modulator includes a wavefront-curvature modulating block modulating a curvature of a wavefront of the light, and wherein the controller controls the wavefront-curvature modulating block to generate the auxiliary virtual image optionally together with the principal virtual image.

The apparatus according to the above mode (3), because of the employment of the wavefront-curvature modulating block adapted to generate the auxiliary virtual image, allows the formation or presentation of the auxiliary virtual image at any desired position in the line of sight of the viewer, or the three-dimentional formation or presentation of the auxiliary virtual image, for example. This apparatus therefore enhances the flexibility in the display format of the auxiliary virtual image.

In the above mode (2) and the following modes, the “three-dimensional display” may be used to mean the presentation of the auxiliary virtual image for itself in a stereoscopic manner, or the presentation of the auxiliary virtual image, which is flat for itself, at a certain angle with the line of sight, allowing the viewer to perceive the differences in depth between points on the auxiliary virtual image.

(4) The apparatus according to mode (3), wherein the controller controls the wavefront-curvature modulating block to form three-dimensionally the auxiliary virtual image optionally together with the principal virtual image, and wherein the auxiliary virtual image is formed so as to extend from a position of the principal display region toward the viewer along a viewing direction in which the viewer is looking.

The apparatus according to the above mode (4) generates the auxiliary virtual image in a manner that allowing the viewer to perceive at least the depth of the auxiliary virtual image.

(5) The apparatus according to mode (4), wherein the controller operates to generate the auxiliary virtual image in the form of selected at least one of;

(a) a perspective linear pattern formed so as to extend from the position of the principal display region toward the viewer along the viewing direction;

(b) a texture density gradient pattern formed so as to extend from the position of the principal display region toward the viewer along the viewing direction, such that local densities of texture of the texture density gradient pattern are varied with corresponding respective distances from the viewer along the viewing direction;

(c) a gradation pattern formed so as to extend from the position of the principal display region toward the viewer along the viewing direction, such that local luminances of the gradation pattern are varied with corresponding respective distances from the viewer along the viewing direction; and

(d) an array of a plurality of separate virtual features disposed along the viewing direction over an area extending from the position of the principal display region toward the viewer, such that the plurality of separate virtual features are varied in size with corresponding respective distances from the viewer along the viewing direction.

The apparatus according to the above mode (5) generates the auxiliary virtual image so as to permit the viewer to more easily perceive the depth of the auxiliary virtual image disposed to extend from the position of the viewer to the position of the principal virtual image. As a result, this apparatus makes it easier for the viewer to correctly perceive the size and distance of the principal virtual image.

(6) The apparatus according to any one of modes (1) through (5), wherein the controller includes a variable generator generating the auxiliary virtual image, such that the auxiliary virtual image is modified as a function of a value indicative of at least one attribute of the display object, the at least one attribute being defined to include at least one of an absolute size of the display object and a distance of the display object from the viewer.

The apparatus according to the above mode (6) generates the auxiliary virtual image variably enough to maintain the appropriate relationship of the auxiliary virtual image with the principal virtual image, although the principal virtual image is variable at least in the absolute size of the principal virtual image and the distance of the principal virtual image from the viewer.

That is to say, this apparatus enables the auxiliary virtual image to be generated in a linked relationship with the principal virtual image, resulting in the maintenance of the appropriate geometrical relationship between the principal and auxiliary virtual images, irrespective of possible changes in the attributes of the principal virtual image.

(7) The apparatus according to mode (6), wherein the modulator includes a wavefront-curvature modulating block modulating a curvature of a wavefront of the light, wherein the controller controls the wavefront-curvature modulating block to form three-dimensionally the auxiliary virtual image optionally together with the principal virtual image, wherein the auxiliary virtual image is formed so as to extend from a position of the principal display region toward the viewer along a viewing direction in which the viewer is looking, and wherein the variable generator includes a first generator generating the auxiliary virtual image, such that an entirety of the auxiliary virtual image is modified as a function of the value indicative of the attribute of the display object.

The apparatus according to the above mode (7) generates the auxiliary virtual image so as to be perceived by the viewer in the auxiliary display region disposed to extend from the position of the principal display region in which the principal virtual image is perceived by the viewer, to the position of the viewer, such that the auxiliary virtual image is modified in accordance with variations in the geometrical properties of the principal virtual image, i.e., the attributes of the display object.

This promotes the viewer to correctly perceive the depth of the principal virtual image (or the distance or how far it is from the viewer) and its size, with the aid of the auxiliary virtual image referred to by the viewer.

(8) The apparatus according to mode (7), wherein the first generator generates the auxiliary virtual image in the form of selected at least one of;

(a) a perspective linear pattern formed so as to extend from the position of the principal display region toward the viewer along the viewing direction, an entirety of the perspective linear pattern being modified as a function of a principal viewing distance between the principal virtual image and the viewer along the viewing direction;

(b) a texture density gradient pattern formed so as to extend from the position of the principal display region toward the viewer along the viewing direction, such that local densities of texture of the texture density gradient pattern are varied with corresponding respective distances from the viewer along the viewing direction, an entirety of the texture density gradient pattern being modified as a function of the principal viewing distance;

(c) a gradation pattern formed so as to extend from the position of the principal display region toward the viewer along the viewing direction, such that local luminances of the gradation pattern are varied with corresponding respective distances from the viewer along the viewing direction, an entirety of the gradation pattern being modified as a function of the principal viewing distance; and

(d) an array of a plurality of separate virtual features disposed along the viewing direction over an area extending from the position of the principal display region toward the viewer, such that the plurality of separate virtual features are varied in size with corresponding respective distances from the viewer along the viewing direction, an entirety of the array being modified as a function of the principal viewing distance.

(9) The apparatus according to any one of modes (6) through (8), wherein the auxiliary virtual image includes a virtual image of a standardized-in-size object that has a standardized absolute size and that has been commonly known, and wherein the variable generator includes a second generator generating the auxiliary virtual image in the form of the virtual image of the standardized-in-size object.

The apparatus according to the above mode (9) allows the viewer to perceive the principal virtual image together with the auxiliary virtual image defining the standardized-in-size object. This makes it easier for the viewer to correctly perceive the absolute size of the principal virtual image, as a result of the viewer's visual comparison with the standardized-in-size object, and further makes it easier for the viewer to correctly perceive the distance of the principal virtual image in association with the perceived size of the principal virtual image.

(10) The apparatus according to mode (9), wherein the second generator generates the virtual image of the standardized-in-size object, such that the standardized-in-size object is perceived by the viewer in the proximity to a position at which the principal virtual image is perceived.

The apparatus according to the above mode (10) makes it easier for the viewer to perceive the principal virtual image and the auxiliary virtual image defining the standardized-in-size object in direct comparison with each other concerning the absolute size of each virtual image, resulting in the viewer's correct perception of the absolute size of the principal virtual image.

(11) The apparatus according to mode (9) or (10), wherein the standardized-in-size object includes at least one of a playing card, a bill, a coin, and a ball for sport.

The apparatus according to the above mode (11) allows the viewer to refer to an object well known to ordinary people concerning the object's absolute size, making it easier for the viewer to correctly perceive the absolute size of the principal virtual image.

(12) The apparatus according to any one of modes (1) through (11), wherein the auxiliary virtual image is lower in luminance or saturation than the principal virtual image.

The apparatus according to the above mode (12) causes the viewer to visually perceive the auxiliary virtual image more weakly than the principal virtual image, making it easier for the viewer to bring attention to the principal virtual image.

(13) The apparatus according to any one of modes (1) through (12), of a see-through type which allows the viewer to perceive the principal and auxiliary virtual images while viewing a real world scene, the apparatus being used with a light occluding element as a real existence which inhibits entry of ambient light from the real world scene into an eye of the viewer, for avoiding the ambient light from affecting the principal virtual image perceived by the viewer, wherein the auxiliary virtual image includes an image of a virtual edge frame surrounding a periphery of the principal display region, and wherein the controller includes a virtual-edge-frame generator generating the virtual edge frame to be perceived by the viewer in the auxiliary display region.

The apparatus according to the above mode (13) allows the viewer to perceive an edge frame surrounding the principal display region not via a real edge frame but via a virtual edge frame.

This apparatus therefore does not require the use of a real existence for producing the viewer's perception of an edge frame around the principal display region.

This apparatus also allows the edge frame to be perceived by the viewer in an optically variable manner, because the viewer's perception of the edge frame of the principal display region does not depend on the use of a real existence of the edge frame.

(14) The apparatus according to mode (13), wherein the virtual-edge-frame generator generates the virtual edge frame to be perceived by the viewer at a distance substantially equal to a distance of the principal virtual image from the viewer.

The apparatus according to the above mode (14) allows the viewer, when attempting to focus the principal virtual image, to focus adequately correctly the virtual edge frame concurrently. This apparatus therefore promotes the viewer to perceive the edge frame of the principal display region as a sharp, in focus virtual image.

As a result, the apparatus according to the above mode (14) avoids the viewer's perception of the principal virtual image from being deteriorated because a real edge portion of the aforementioned light occluding element is perceived by the same viewer as a fuzzy, out of focus image.

(15) The apparatus according to mode (14), wherein the virtual-edge-frame generator includes a variable generator generating the virtual edge frame so as to be perceived by the viewer at a varying distance in accordance with a varying position at which the principal virtual image is perceived by the viewer.

The apparatus according to the above mode (15) generates the virtual edge frame to be perceived by the viewer at a distance variable with changes in the position of the perceived principal virtual image, making it easier for the viewer to perceive the edge frame of the principal display region as a sharp, in focus image, irrespective of movements of the perceived principal virtual image. This results in the easier improvement in the reality of the virtual edge frame.

(16) The apparatus according to any one of modes (1) through (12), of a see-through type which allows the viewer to perceive the principal and auxiliary virtual images while viewing a real world scene, the apparatus being used with a physical edge frame disposed to surround a periphery of the principal display region, and a black-colored physical member for occluding ambient light coming from the real world scene, the physical member being disposed and dimensioned so as to cover the physical edge frame and so as to fill a space defined by and within the physical edge frame, wherein the controller operates to generate the auxiliary virtual image for allowing the viewer to perceive the auxiliary virtual image so as to extend along a viewing direction in which the viewer is looking, and so as to have both ends spaced apart in the viewing direction, a proximal one of which is disposed substantially at the physical edge frame.

(17) The apparatus according to any one of modes (13) through (16), wherein the virtual edge frame is not less in luminance than the real world scene.

The apparatus according to the above mode (17), although it theoretically permits light from the real world scene to enter the viewer through the virtual edge frame (i.e., the virtual edge frame is not solid but transparent), generates the virtual edge frame with the luminance equal to or higher than that of the real world scene, resulting in the viewer's perception of the virtual edge frame except the real world scene.

The apparatus according to the above mode (17) therefore allows the viewer to perceive as if the virtual edge frame of the principal display region were a real edge frame, irrespective of the edge frame of the principal display region being generated with the virtual edge frame which is less occlusive (more transmissive) than the real edge frame.

(18) The apparatus according to any one of modes (1) through (17), wherein the auxiliary virtual image is generated using image data which has been previously stored or is timely produced in the apparatus.

The apparatus according to the above mode (18) does not require entry from the outside of image data required for generating the auxiliary virtual image, conducive to the enhanced independence of the instant apparatus.

(19) The apparatus according to any one of modes (1) through (17), wherein the auxiliary virtual image is generated using image data which enters the apparatus from a separate apparatus for processing information.

The apparatus according to the above mode (19) allows a temporal internal storage of image data required for generating the auxiliary virtual image, without requiring a long-term internal storage of the image data.

The apparatus according to the above mode (19) may be practiced in an arrangement allowing the auxiliary virtual image to be generated using the image data entered from the separate apparatus for processing information, without any substantial modification to the entered image data, or in an arrangement allowing the auxiliary virtual image to be generated using the entered image data with required modifications thereto, for example.

(20) The apparatus according to any one of modes (1) through (19), wherein the emitter emits the light in the form of a beam of light, further comprising a scanner scanning the beam of light emitted from the emitter, the apparatus functioning as a retinal scanning display device.

(21) A method of projecting modulated light onto a retina of a viewer, to thereby allow the viewer to perceive a display object via a virtual image, the method comprising the steps of:

generating a principal virtual image defining the display object, to be perceived by the viewer in a principal display region of an image display field; and

generating an auxiliary virtual image to be perceived by the viewer in an auxiliary display region which is located in the image display field in a predetermined positional relationship with the principal display region, as viewed from the viewer.

The method according to the above mode (21) provides the same effects as the apparatus according to the above mode (1) provides.

(22) The method according to mode (21), wherein the step of generating the auxiliary virtual image includes a step of cueing the viewer with the auxiliary virtual image, to promote perception by the viewer of at least one attribute of the display object, the at least one attribute being defined to include at least one of an absolute size of the display object and a distance of the display object from the viewer.

The method according to the above mode (22) provides the same effects as the apparatus according to the above mode (2) provides.

Several presently preferred embodiments of the invention will be described in detail by reference to the drawings in which like numerals are used to indicate like elements throughout.

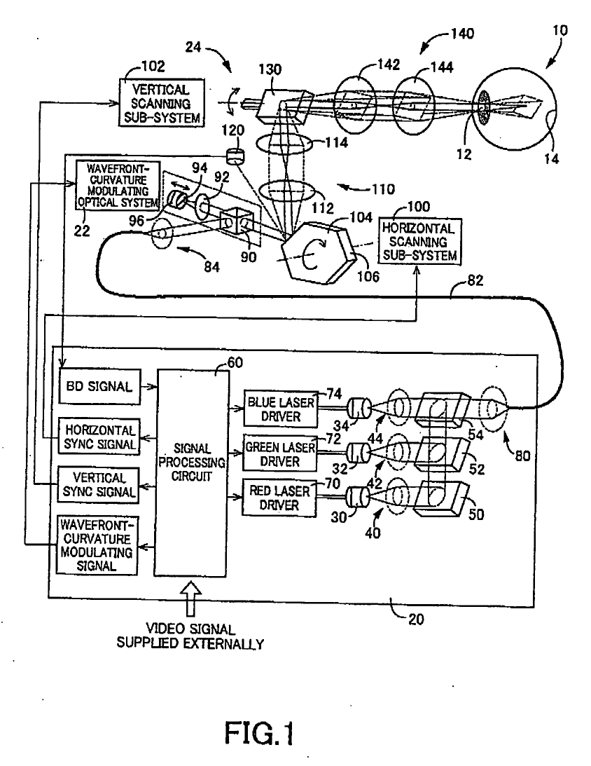

Referring now to FIG. 1, a retinal-scanning-type display device (hereinafter, abbreviated as “RSD”) according to a first embodiment of the present invention is systematically illustrated. This RSD is an image display device of a type that projects light defining a display object through a pupil 12 of a viewer's eye 10 onto a retina 14 of the viewer, to thereby allow the viewer to perceive the display object via a virtual image.

More specifically, this RSD is configured, such that a laser beam, while it is necessarily modulated in the curvature of wavefront and the intensity of the laser beam, impinges onto an image plane on the retina 14 through the pupil 12, and such that the laser beam incident on the retinal image plane is two-dimensionally scanned thereon, whereby the laser beam defining a desired image is directly projected onto the retina 14.

That is to say, in the present embodiment, this RSD constitutes an example of the “apparatus” according to the above mode (1), and the laser beam constitutes an example of the “light” set forth in the same mode.

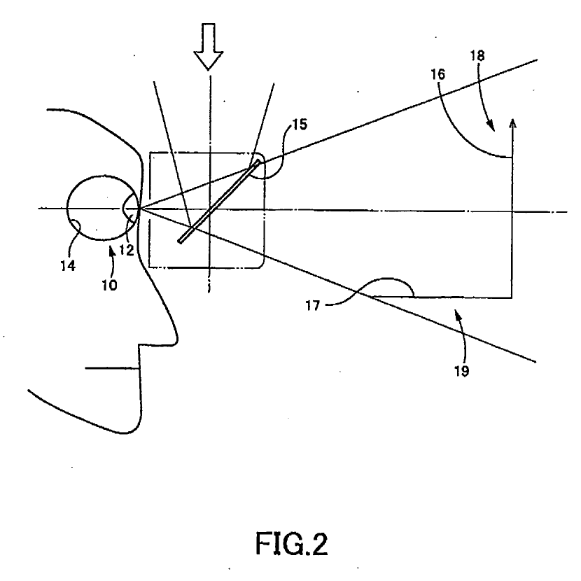

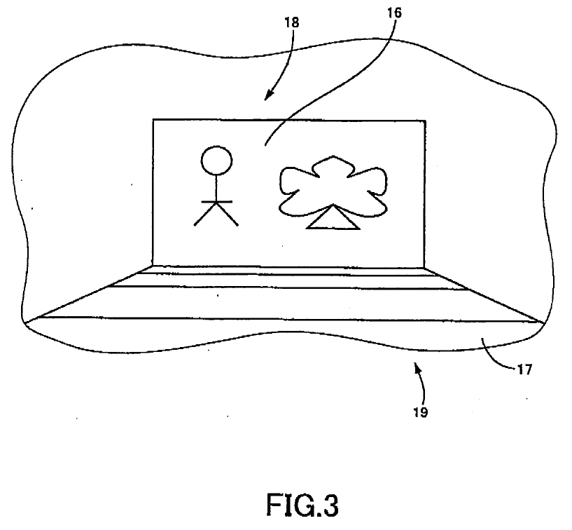

This RSD, because of the selection of an enclosed type, as illustrated in FIGS. 2 and 3, is configured to display only a virtual image defining a display object, with light from the real world being occluded by a housing of this RSD (illustrated in FIGS. 2 and 3 in two-dotted lines). A mirror 15, although it is a part of this RSD, is omitted in illustration in FIG. 1.

In the present embodiment, as illustrated in FIGS. 2 and 3, a virtual image includes a principal virtual image 16 defining a display object or a visual content, and an auxiliary virtual image 17 which is generated to promote the viewer's perception of the distance of the display object from the viewer. In the present embodiment, the auxiliary virtual image 17 functions as an artificial depth cue for the principal virtual image 16, as described later.

Accordingly, a virtual image display field where virtual images are perceived by the viewer with this RSD is defined to include a virtual principal display region 18 in which the principal virtual image 16 is perceived or viewed by the viewer, and a virtual auxiliary display region 19 in which the auxiliary virtual image 17 is perceived or viewed by the viewer.

This RSD enables the viewer to perceive the principal virtual image 16 while perceiving the auxiliary virtual image 17, making it easier for the viewer to correctly perceive the distance and depth of the principal virtual image 16, and making it easier for the viewer to correctly perceive the absolute size of the principal virtual image 16, in association with the viewer's perception of distance and depth.

In the present embodiment, as illustrated in FIGS. 2 and 3, the principal virtual image 16 appears to be two-dimensional, i.e., without any depth variation, while the auxiliary virtual image 17 appears to be three-dimensional, i.e., with depth variations, although the principal and auxiliary virtual images 16 and 17 are each formed to be flat.

The principal virtual image 16 can be generated so as to be perceived by the viewer at a varying position, allowing the principal virtual image 16 to be perceived at a varying distance of the principal virtual image 16 from the viewer (hereinafter, referred to as “principal viewing distance”). That is to say, the position of the perceived principal virtual image 16 is not fixed.

As illustrated in FIG. 2, in the present embodiment, the auxiliary virtual image 17 is so defined as to extend from the position of the principal display region 18 toward the viewer. The auxiliary virtual image 17 appears in a single plane which is not perpendicular to a line of sight of the viewer (illustrated in dot-dash lines in FIG. 2), namely, in the present embodiment, a single plane which is parallel to the line of sight. As a result, the auxiliary virtual image 17, although it is formed to be flat for itself, is perceived to be three-dimensional by the viewer.

In the present embodiment, as illustrated in FIG. 3, the auxiliary virtual image 17 is in the form of a perspective linear pattern which is formed to extend from the position of the principal display region 18 toward the viewer.

The auxiliary virtual image 17 appears, such that the entirety of the perspective linear pattern is modified or varied as a function of the aforementioned principal viewing distance. The auxiliary virtual image 17 can be obtained by considering a geometrical set of parallel lines so arranged in the real space as to have given individual lengths and equally disposed apart from each other, and by performing a well-known projective transformation for the geometrical set of parallel lines.

More specifically, the auxiliary virtual image 17 can be obtained as a daily familiar pattern according to which parallel lines are arrayed in a viewing direction in which the viewer is looking, such that the lengths of the lines and the intervals between adjacent twos of the lines become smaller as it goes from the side of the viewer toward the side of the principal virtual image 16.

Further, in the present embodiment, the auxiliary virtual image 17 appears with a luminance or color saturation lower than the principal virtual image 16.

How to present the principal and auxiliary virtual images 16 and 17 with this RSD will be described below in more detail, with the definition that the referring simply to “image” indicates a combination of the principal and auxiliary virtual images 16 and 17.

As illustrated in FIG. 1, this RSD includes a light source unit 20, and a wavefront-curvature modulating optical system 22 and a scanning unit 24 both of which are disposed in the description order between the light source unit 20 and the viewer's eye 10.

In order to generate a light beam of any color by combining sub-beams of light of three primary colors (i.e., red, green, and blue), the light source unit 20 includes a laser 30 emitting a sub-beam of red colored light, a laser 32 emitting a sub-beam of green colored light, and a laser 34 emitting a sub-beam of blue colored light. These lasers 30, 32, and 34 each can be constructed as a semiconductor laser, for example.

The sub-beams of light of three primary colors emitted from the respective lasers 30, 32, and 34, after collimated by respective collimating optical systems 40, 42, and 44, enter respective dichroic mirrors 50, 52, and 54 all of which are wavelength-selective. This is for causing the sub-beams of light to be selectively reflected from or transmitted through the respective dichroic mirrors 50, 52, and 54, in response to the wavelengths of these sub-beams of light, to thereby eventually combine the sub-beams of light.

More specifically, the sub-beam of red colored light emitted from the laser 30, after collimation by the collimating optical system 40, enters the dichroic mirror 50. The sub-beam of green colored light emitted from the laser 32, after collimation by the collimating optical system 42, enters the dichroic mirror 52. The sub-beam of blue colored light emitted from the laser 34, after collimation by the collimating optical system 44, enters the dichroic mirror 54.

The sub-beams of light of three primary colors, upon entry into the respective dichroic mirrors 50, 52, and 54, are combined together at the dichroic mirror 54, which is a representative one of the dichroic mirrors 50, 52, and 54. The combined sub-beams of light enter a combing optical system 80 to be focused thereonto.

Although the optical section of the light source unit 20 has been described above, then there will be described the electrical section of the light source unit 20.

The light source unit 20 includes a signal processing circuit 60. The signal processing circuit 60 is configured to perform, in response to an externally-supplied video signal, signal processing for driving the lasers 30, 32, and 34; signal processing for modulating the curvature of wavefront of the laser beams, as described below; and signal processing for implementing a scanning operation of the combined beam of laser, as described below.

In operation, the signal processing circuit 60 supplies drive signals for driving each laser 30, 32, 34, in response to the externally-supplied vide signal, for per pixel on the desired image to be projected onto the retina 14. These drive signals, which are required for the desired color and intensity of the combined beam of laser, are routed to the corresponding respective lasers 30, 32, and 34 via corresponding respective laser drivers 70, 72, and 74.

As is apparent from the above, in the present embodiment, the light source unit 20 constitutes an example of the “emitter” set forth in the above mode (1).

The light source unit 20 described above emits the combined beam of laser at the combining optical system 80. The laser beam, after emerging from the combing optical system 80, enters and passes through an optical fiber 82 and a collimating optical system 84 arrayed in the description order. The optical fiber 82 functions as a light transmissive media, and the collimating optical system 84 collimates the laser beam exiting divergently the optical fiber 82 at its rearward end.

The laser beam, after passing through the optical fiber 82 and the collimating optical system 84, enters the wavefront-curvature modulating optical system 22.

The wavefront-curvature modulating optical system 22 is an optical system that modulates the curvature of wavefront of the laser beam emitted from the light source unit 20, for per pixel on the desired image to be projected onto the retina 14.

More specifically, the wavefront-curvature modulating optical system 22 is configured principally by combining a converging lens and a movable mirror which is displaceable along the optical axis of the converging lens.

Still more specifically, the wavefront-curvature modulating optical system 22 includes a semi-transparent mirror (or beam splitter) 90 which the laser beam exiting the collimating optical system 84 enters; and a converging lens 92 which converges the laser beam which is reflected from the semi-transparent mirror 90 into the converging lens 92.

The wavefront-curvature modulating optical system 22 further includes a movable mirror 94 having a flat mirror portion causing the laser beam exiting the converging lens 92 to be reflected from the flat mirror portion; and an actuator 96 for displacing the movable mirror 94 along the optical axis. An example of the actuator 96 may be of a type employing a piezoelectric device.

In operation of the wavefront-curvature modulating optical system 22, the laser beam, upon reflection from the movable mirror 94 into the converging lens 92 and the semi-transparent mirror 90 and passing therethrough, enters the aforementioned scanning unit 24.

It is added that there may be employed an alternative approach in which the wavefront-curvature modulating optical system 22 modulates the curvature of wavefront of the laser beam.

In an example of such an alternative approach, there is used a variable focus lens (or varifocal lens) whose focal length is capable of being varied by an actuator, and the curvature of a reflective surface of the variable focus lens from which an incident laser beam is reflected is varied, leading to the modulation in the curvature of wavefront of the laser beam.

The aforementioned signal processing circuit 60 is configured to generate, in response to an externally-supplied video signal, a wavefront-curvature modulating signal which is required to be supplied to the actuator 96 for the modulation in the curvature of wavefront of the laser beam, and to supply the generated wavefront-curvature modulating signal to the actuator 96. This processing is the aforementioned signal processing for modulating the laser beam in the curvature of wavefront.

In response to the supplied wavefront-curvature modulating signal, the actuator 96 modulates the curvature of wavefront of the laser beam to be emerged from the wavefront-curvature modulating optical system 22.

That is to say, in the present embodiment, the wavefront-curvature modulating optical system 22 constitutes an example of the “modulator” set forth in the above mode (1).

The laser beam, upon exit from the wavefront-curvature modulating optical system 22 configured in a manner described above, enters the aforementioned scanning unit 24. The scanning unit 24 includes a horizontal scanning sub-system 100 and a vertical scanning sub-system 102.

The horizontal scanning sub-system 100 is an optical system for performing horizontal scan (an example of primary scan) in which a laser beam is scanned periodically and repeatedly in a given direction (a horizontal direction, in the present embodiment). On the other hand, the vertical scanning sub-system 102 is an optical system for performing vertical scan (an example of secondary scan) in which a laser beam is scanned, on a frame-by-frame basis of the desired image to be displayed, in a vertical direction from the first scan line toward the last scan line on the same frame.

More specifically, in the present embodiment, the horizontal scanning sub-system 100 includes a polygon mirror 104 as a unidirectional rotating mirror that causes mechanical deflection of a laser beam incident thereon. The polygon mirror 104 is rotated at a higher speed by a motor (not shown), about an axis of rotation which intersects the optical axis of the laser beam entering the polygon mirror 104. The rotation of the polygon mirror 104 is controlled in response to a horizontal sync signal supplied from the signal processing circuit 60.

The polygon mirror 104, which includes a plurality of mirror facets 106 circled around the axis of rotation of the polygon mirror 104, performs each cycle of deflection of a laser beam each time the laser beam passes circumferentially through one of the mirror facets 106. Upon deflection, the laser beam is relayed to the vertical scanning sub-system 102 via a relay optical system 110. In the present embodiment, the relay optical system 110 includes a plurality of optical elements 112 and 114 in an array along the optical path of the laser beam.

This RSD is provided with a beam detector 120 at a fixed position relative to this RSD, which detects a laser beam which has been deflected by the polygon mirror 104 (i.e., a laser beam which has been scanned in a first scan direction), to thereby measure the position of the scanned laser beam in the first scan direction. An example of the beam detector 120 may be a photodiode.

The beam detector 120 outputs a BD signal indicating that a scanned laser beam has reached a predetermined position, and the output BD signal is delivered to the signal processing circuit 60. In response to the delivery of the BD signal from the beam detector 120, the signal processing circuit 60 applies appropriate drive signals to the respective laser drivers 70, 72, and 74, upon elapse of a predetermined length of time since the beam detector 120 detected latest the laser beam.

This identifies the timing at which displaying an image is to be initiated on a per scan-line basis, and at the identified timing, displaying an image is initiated on a per scan-line basis.

In contrast to the horizontal scanning sub-system 100 which has been described above, the vertical scanning sub-system 102 includes a galvano mirror 130 as an oscillating mirror that causes mechanical deflection of a laser beam incident thereon.

The galvano mirror 130 is disposed to allow entry into the galvano mirror 130 of a laser beam after exiting the horizontal scanning sub-system 100 and being converged by the relay optical system 110. The galvano mirror 130 is oscillated about an axis of rotation intersecting the optical axis of the laser beam entering the galvano mirror 130. The start-up timing and the rotational speed of the galvano mirror 130 is controlled in response to a vertical sync signal supplied from the signal processing circuit 60.

The horizontal scanning sub-system 100 and the vertical scanning sub-system 102 both described above cooperate together to scan a laser beam two-dimensionally, and image light formed by the scanned laser beam enters the viewer's eye 10 via a relay optical system 140. In the present embodiment, the relay optical system 140 includes a plurality of relay optical elements 142 and 144 in an array along the optical path of the laser beam.

As illustrated in FIG. 2, the laser beam exiting the relay optical system 140 is reflected from a mirror 15 and then enters the retina 14 via the pupil 12.

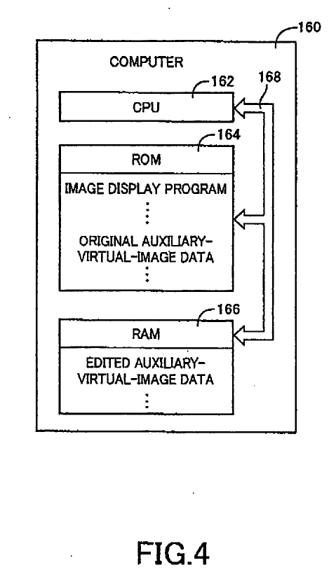

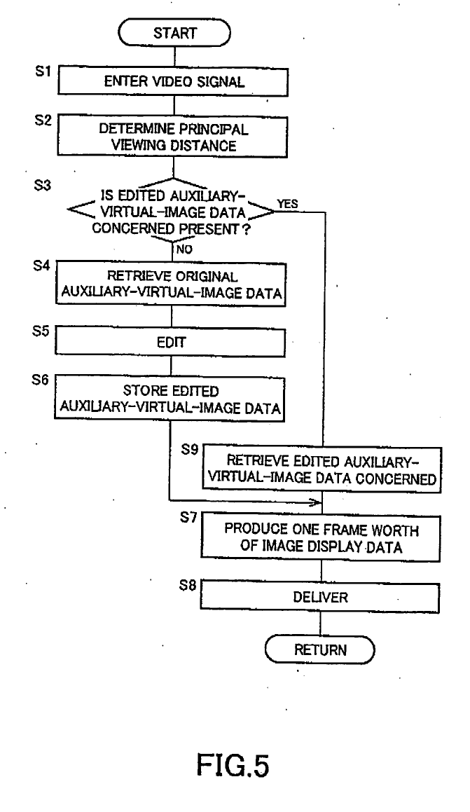

The signal processing circuit 60 illustrated in FIG. 1 is configured principally by a computer 160 illustrated in FIG. 4. As is well known, the computer 160 is configured by interconnecting a CPU 162, a ROM 164, and a RAM 166, via a bus 168, as illustrated in FIG. 4. The ROM 164 has previously stored therein various programs including an image display program which is illustrated in FIG. 5 schematically in flow chart.

As illustrated in FIG. 4, the ROM 164 has previously stored therein additionally image data for allowing the viewer to perceive or view the auxiliary virtual image 17 at the principal viewing distance having a standard value, in the name of original auxiliary-virtual-image data.

The original auxiliary-virtual-image data is edited to reflect an actual value of the principal viewing distance at which the principal virtual image 16 is to be perceived by the same viewer together with the auxiliary virtual image 17, This results in the generation of edited auxiliary-virtual-image data for allowing the viewer to perceive an ultimate auxiliary-virtual-image. As illustrated in FIG. 4, the edited auxiliary-virtual-image data is entered into and stored temporarily in the RAM 166, in association with the actual value of the principal viewing distance.

Then, the aforementioned image display program will be described below in more detail by reference to FIG. 5.

The image display program is repeatedly executed while the computer 160 is being powered. Each cycle of execution of the image display program begins with a step S1 to externally enter one image frame worth of a video signal for an image to be currently displayed.

The step S1 is followed by a step S2 to determine the principal viewing distance of a current frame to be displayed, in response to the entered video signal. The currently-determined principal F viewing distance will be referred to as “current value of the principal viewing distance.” As a result, the display position of the principal virtual image 16 in the viewing direction is identified for the current frame of image to be displayed.

The step S2 is followed by a step S3 to make a determination as to whether or not the RAM 166 has previously stored therein the edited auxiliary-virtual-image data in association with the principal viewing distance equal to that determined for the current frame of image. If the RAM 166 has not yet stored therein the edited auxiliary-virtual-image, then the determination of the step S3 becomes negative “NO,” and the computer 160 proceeds to a step S4.

The step S4 is implemented to retrieve the original auxiliary virtual image data from the ROM 164. The step S4 is followed by a step S5 to edit the currently-retrieved original auxiliary-virtual-image data to be matched with the current value of the principal viewing distance, resulting in the generation of the edited auxiliary-virtual-image data. This requires the implementation of a graphic transformation (geometrical transformation) for the original auxiliary-virtual-image data, for example.

The step S5 is followed by a step S6 to store the edited auxiliary-virtual-image data in the RAM 166 in association with the current value of the principal viewing distance. The step S6 is followed by a step S7, in response to the aforementioned entered video signal, to combine data for allowing the viewer to perceive the principal virtual image 16, with the edited auxiliary-virtual-image data, to thereby generate the current frame worth of the image display data.

The step S7 is followed by a step S8, in response to the thus-generated image display data, to produce the drive signals to be supplied to the respective laser drivers 70, 72, and 74, and the wavefront-curvature modulating signals to be supplied to the wavefront-curvature modulating optical system 22. The wavefront-curvature modulating signals are produced to modulate a laser beam, such that the principal virtual image 16 appears at the principal viewing distance having the current value, and such that the auxiliary virtual image 17 appears to be three-dimensional.

The step S8 is further implemented to deliver the produced driving signals to the respective laser drivers 70, 72 and 74, and to deliver the produced wavefront-curvature modulating signal to the wavefront-curvature modulating optical system 22.

The wavefront-curvature modulating optical system 22 is capable of modulating the curvature of wavefront of a laser beam on a pixel-by-pixel basis for the aforementioned virtual image display field (i.e., an optical field of view). This therefore enables the wavefront-curvature modulating optical system 22 to form the auxiliary virtual image 17 three-dimensionally.

Then, one cycle of the execution of the image display program is terminated.

The above description was made for the case where there does not exist in the RAM 166 the edited auxiliary-virtual-image data that relates to the current frame of image to be displayed. In contrast to that, if the edited auxiliary-virtual-image data exists in the RAM 166, then the determination of the step S3 becomes affirmative “YES,” and the steps S4 through S6 are skipped.

In this case, the step S3 is followed by a step S9 to retrieve from the RAM 166 the edited auxiliary virtual image data that relates to the current value of the principal viewing distance. Thereafter, the steps S7 and S8 are implemented in the same manner as with the previous case.

As will be evident from the above description, in the present embodiment, the signal processing circuit 60 constitutes an example of the “controller” set forth in the above mode (1), and a portion of the computer 160 which is assigned to implement the steps S3 through S9 shown in FIG. 5 constitutes an example of the “cueing block” set forth in the above mode (2).

Further, in the present embodiment, the wavefront-curvature modulating optical system 22 constitutes an example of the “wavefront-curvature modulating block” set froth in the above mode (3), a portion of the computer 160 which is assigned to implement the steps S3 through S9 shown in FIG. 5 constitutes an example of the “controller” set forth in any one the above modes (3) through (5), and the auxiliary virtual image 17 constitutes an example of the “auxiliary virtual image” set forth in the above mode (4) or (5).

Still further, in the present embodiment, a portion of the computer 160 which is assigned to implement the steps S2, S4, and S5 constitutes an example of the “variable generator” set forth in the above mode (6) and an example of the “first generator” set forth in the above mode (7) or (8). The wavefront-curvature modulating optical system 22 constitutes an example of the “wavefront-curvature modulating block” set forth in the above mode (7). The auxiliary virtual image 17 constitutes an example of the “auxiliary virtual image” set forth in the above mode (7), (8), or (12).

Yet further, in the present embodiment, the original auxiliary-virtual-image data constitutes an example of the “image data” set forth in the above mode (18).

Next, an RSD constructed according to a second embodiment of the present invention will be described.

The present embodiment is in common to the first embodiment concerning many elements, and is different from the first embodiment only concerning the elements relating to the presentation of an auxiliary virtual image data.

In view of that, while the common elements of the present embodiment will be referenced the same reference numerals or names as those in the description and illustration of the first embodiment, without redundant description or illustration, the different elements of the present embodiment will be described below in greater detail.

In the first embodiment, the auxiliary virtual image 17 is in the form of a perspective linear pattern, to thereby support the viewer in correctly perceiving the distance and the size of the principal virtual image 16.

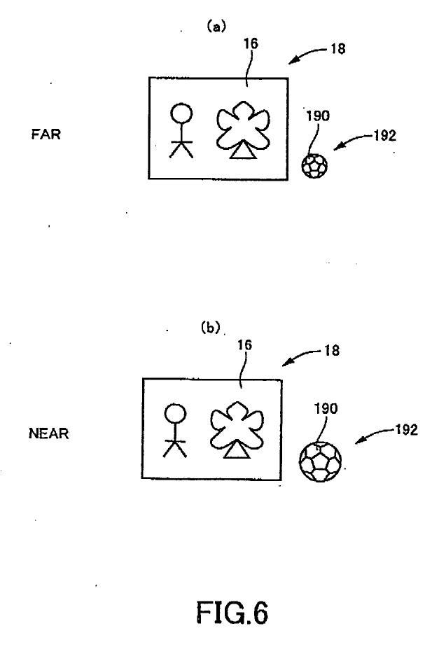

Instead, the present embodiment employs, as illustrated in FIG. 6, an auxiliary virtual image 190 in the form of a virtual image of a standardized-in-size object, the size of which has been standardized, and has been commonly known to the public.

As illustrated in FIG. 6, in the present embodiment, a soccer ball is selected as the standardized-in-size object. That is to say, the auxiliary virtual image 190 is perceived by the viewer in the form of a virtual image of a soccer ball. The auxiliary virtual image 190 is viewed by the viewer in an auxiliary display region 192 defined to be appeared in the vicinity of the display position of the principal virtual image 16, as illustrated in FIG. 6.

FIG. 6(a) illustrates in front view an example of the auxiliary virtual image 190 which is perceived by the viewer when the principal virtual image 16 appears at a distant position from the viewer. On the other hand, FIG. 6(b) illustrates in front view an example of the auxiliary virtual image 190 which is perceived by the viewer when the principal virtual image 16 appears at a near position. As is apparent from FIGS. 6(a) and 6(b), the size of the auxiliary virtual image 190 perceived is varied as a function of the distance of the F principal virtual image 16 from the viewer.

In the present embodiment, the auxiliary virtual image 190 is generated to be perceived by the viewer with a varying size, as described above.

For achieving the variable generation or variable perception of the auxiliary virtual image 190, the signal processing circuit 60 of the RSD according to the present embodiment is configured, such that the RON 164 has previously stored therein original auxiliary-virtual-image data for allowing the viewer to perceive or interpret the auxiliary virtual image 190 as a soccer ball, and such that the computer 160 executes an image display program in common to the image display program illustrated in FIG. 5, using the stored original auxiliary-virtual-image data.

Further, in the present embodiment, the auxiliary virtual image 190 is generated to appear to be lower in luminance or color saturation than the principal virtual image 16, in a similar manner to the first embodiment.

Therefore, the present embodiment allows the viewer to perceive or view the principal virtual image 16 in a direct comparison with the auxiliary virtual image 190, resulting in an easier achievement of the viewer's correct perception of the absolute size of the principal virtual image 16, produced by the absolute size of the auxiliary virtual image 190 which is inferred or imagined from the auxiliary virtual image 190.

Additionally, the present embodiment makes it easier for the viewer to correctly perceive the distance of the principal virtual image 16 owing to the direct comparison with the auxiliary virtual image 190.

As will be evident from the above description, in the present embodiment, the auxiliary virtual image 190 constitutes an example of the “auxiliary virtual image” set forth in the above mode (1), (2), (6), or (12). A portion of the signal processing circuit 60 which is assigned to execute the aforementioned image display program constitutes an example of the “controller” set forth in the above mode (1), an example of the “controller” set forth in the above (3), and an example of the “variable generator” set forth in the above mode (6). A portion of the signal processing circuit 60 which is assigned to implement the steps corresponding to the steps S2-S9 constitutes an example of the “first generator” set forth in the above mode (7).

Further, in the present embodiment, the auxiliary virtual image 190 constitutes an example of the “virtual image of standardized-in-size object” set forth in the above mode (9), a portion of the signal processing circuit 60 which is assigned to implement the steps corresponding to the steps S2-S9 constitutes an example of the “second generator” set forth in the same mode or the above mode (10), and the soccer ball constitutes an example of the “standardized-in-size object” set forth in the above mode (11).

Next, an RSD constructed according to a third embodiment of the present invention will be described.

The present embodiment is common to the first embodiment concerning many elements, and is different from the first embodiment only concerning the elements relating to the acquisition of an auxiliary virtual image.

In view of that, while the common elements of the present embodiment will be referenced the same reference numerals or names as those in the description and illustration of the first embodiment, without redundant description or illustration, the different elements of the present embodiment will be described below in greater detail.

The RSD according to the first embodiment is configured, for allowing the viewer to perceive the auxiliary virtual image 17, such that the original auxiliary virtual image data has been previously stored in the ROM 164, and is edited as desired for application. Therefore, the presentation of the auxiliary virtual image 17 does not require any dependency on a separate external apparatus.

In contrast, in the RSD according to the present embodiment, once it becomes necessary to present the auxiliary virtual image 17, data concerned enters this RSD from the external, and the data entered is edited for application, allowing the auxiliary virtual image 17 to be presented.

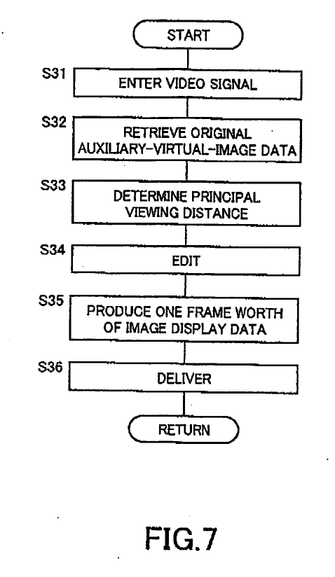

For presenting the auxiliary virtual image 17 in the above manner, this RSD according to the present embodiment is configured, such that the ROM 164 has stored therein an image display program. FIG. 7 illustrates the image display program schematically in flow chart.

Then, this image display program will be described in greater detail, some steps of which are in common to those of the image display program illustrated in FIG. 5 in the first embodiment. The common steps of this image display program will be briefly explained.

The execution of this image display program begins with a step S31 to enter a video signal, similarly with the step S1 illustrated in FIG. 5. The step S31 is followed by a step S32 to enter the original auxiliary-virtual-image data from an external apparatus for processing information, by cable or wireless.

If the original auxiliary-virtual-image data is categorized into various kinds, then a certain kind of the original auxiliary-virtual-image data (for example, a certain kind of the auxiliary virtual image 17) is designated by a user of the RSD, prior to entry of the content of the original auxiliary-virtual-image data.

The step S32 is followed by a step S33 to determine a current value of the aforementioned principal viewing distance for a current principal virtual image 16, similarly with the step S2 illustrated in FIG. 5. The step S33 is followed by a step S34 to edit the entered original auxiliary-virtual-image data so as to be matched with the determined current value of the principal viewing distance, similarly with the step S5 illustrated in FIG. 5.

The step S34 is followed by a step S35 to compose image display data for a current frame of image to be displayed, and to produce the desired driving signals and wavefront-curvature modulating signal, similarly with the step S7 illustrated in FIG. 5. The step S35 is followed by a step S36 to deliver the produced driving signals to the respective laser drivers 70, 72, and 74, and to deliver the produced wavefront-curvature modulating signal to the wavefront-curvature modulating optical system 22.

Then, one cycle of the execution of this image display program is terminated.

As will be evident from the above description, in the present embodiment, the original auxiliary-virtual-image data constitutes an example of the “image data” set forth in the above mode (19).

Next, an RSD constructed according to a fourth embodiment of the present invention will be described.

The present embodiment is common to the first embodiment concerning many elements. In view of that, while the common elements of the present embodiment will be referenced the same reference numerals or names as those in the description and illustration of the first embodiment, without redundant description or illustration, the different elements of the present embodiment will be described below in greater detail.

The RSD according to the first embodiment is formed to be of an enclosed type in which a desired image is solely perceived by the viewer without viewing the real world view of the ambient environment.

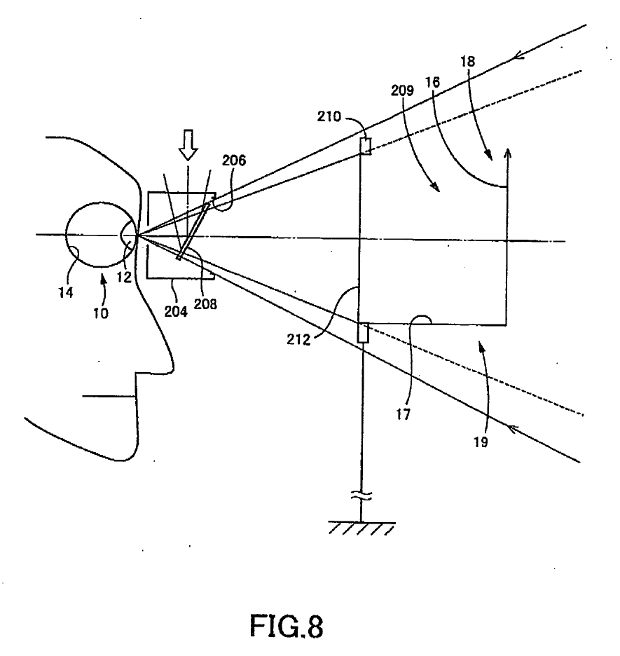

In contrast, the RSD according to the present embodiment is formed to be of a see-through type. Therefore, as illustrated in FIG. 8, this see-through RSD, once activated, allows the viewer to perceive the principal virtual image 16 defining a display object and the auxiliary virtual image 17, with light from the real world (illustrated in FIG. 8 in arrowed solid lines) entering the viewer's eye 10 after passing through an aperture 206 formed in a housing 204 of this RSD and a semi-transparent mirror 208.

This allows the viewer to visually perceive the principal and auxiliary virtual images 16 and 17, with the real world view being fused therewith. To this end, in the present embodiment, the semi-transparent mirror 208 is used instead of the mirror 15 used in the first embodiment.

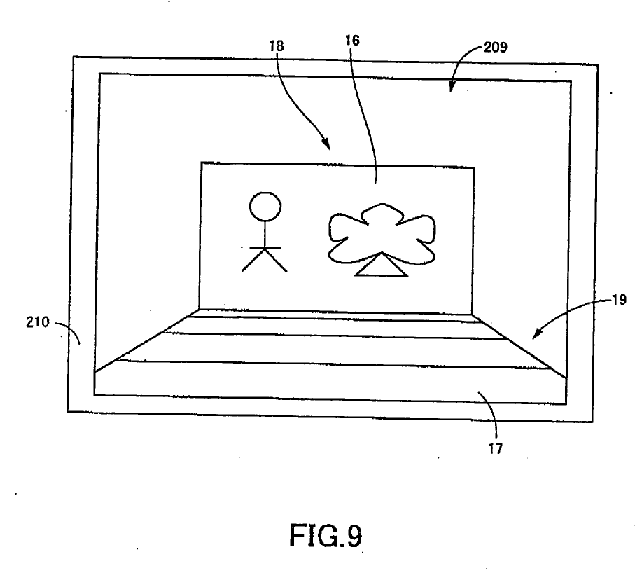

Further, this RSD according to the present embodiment, as illustrated in FIGS. 8 and 9, is used along with a real edge frame 210 which is disposed in front of the viewer, so that an image display field (i.e., an optical field of view) 209 in which the principal virtual image 16 and the auxiliary virtual image 17 appear may be edged, to thereby produce a clear distinction from the real world view. The edge frame 210 is colored white at at least visible side to the viewer.

As illustrated in FIGS. 8 and 9, the edge frame 210 is so disposed as to coincide in position with a proximal one of both longitudinal ends of the auxiliary virtual image 17 extending along the viewer's line of sight (illustrated in dot-dash lines in FIG. 8). This allows the viewer to perceive the auxiliary virtual image 17 so as to extend horizontally from the inner edge of the edge frame 210 toward the principal virtual image 16.

Further, in the present embodiment, a physical screen 212 is attached to the edge frame 210 in a manner that a space within the edge frame 210 is covered flat with the screen 212. The screen 212 is colored black to prevent entry of light from the real world into the viewer's eye 10 and to eventually prevent the external light from adversely affecting the viewer's perception of the principal virtual image 16. Hence, the screen 212 functions as a light occluding element or member for producing the viewer's stable perception of the principal virtual image 16.

In the present embodiment, the edge frame 210 is vertically disposed at a proximal one of both ends of the auxiliary virtual image 17 which are spaced apart in the viewing direction. More specifically, the edge frame 210 is disposed such that an inner peripheral edge of the edge frame 210 is coincident with the proximal end of the auxiliary virtual image 17.

Further, in the present embodiment, the screen 212 is disposed and dimensioned so as to cover a frontal face of the edge frame 210 and so as to fill a space defined by and within the edge frame 210.

Next, an RSD constructed according to a fifth embodiment of the present invention will be described.

The present embodiment is common to the first embodiment concerning many elements. In view of that, while the common elements of the present embodiment will be referenced the same reference numerals or names as those in the description and illustration of the first embodiment, without redundant description or illustration, the different elements of the present embodiment will be described below in greater detail.

The RSD according to the first embodiment is formed to be of an enclosed type, and is operated to form the auxiliary virtual image 17 for promoting the viewer's correct perception of the distance between the viewer and the principal virtual image 16.

In contrast, the RSD according to the present embodiment is formed to be of a see-through type, similarly with the RSD in the fourth embodiment.

In the fourth embodiment, the real edge frame 210 is employed to edge the image display field 209 around its entire circumference. The image display field 209 includes the principal display region 18 in which the principal virtual image 16 is perceived; and the auxiliary display area 19 in which the auxiliary virtual image 17 is perceived. Further, the screen 212 for shielding light from the real world is provided independently of the RSD.

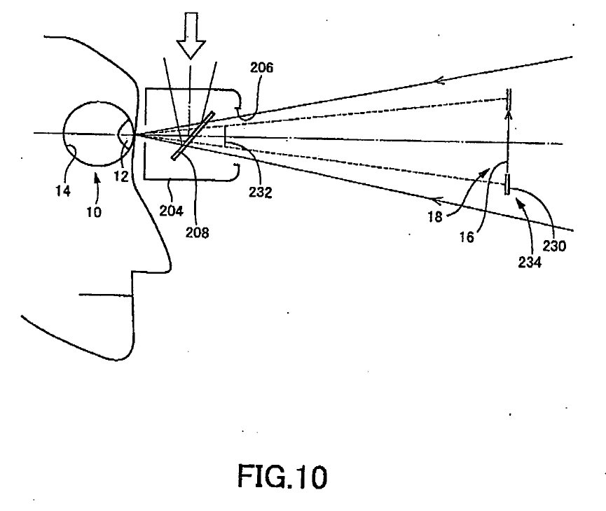

In contrast, as illustrated in FIG. 10, the RSD according to the present embodiment employs an auxiliary virtual image in the form of a virtual edge frame 230 for edging the principal display region 18 in which the principal virtual image 16 is perceived. Further, in the present embodiment, a light occluding element 232 for occluding light from the real world is provided to this RSD so as to be integrally movable with this RSD.

More specifically, as illustrated in FIG. 10, the light occluding element 232 is disposed within the housing 204 of this RSD behind the semi-transparent mirror 208. The light occluding element 232 may be disposed so as to be supported by the semi-transparent mirror 208, for example. The light occluding element 232 may be of an on/off switching type employing a liquid-crystal shutter or the like.

In operation of the present embodiment, the virtual edge frame 230 is perceived by the viewer at a position substantially equal in the distance from the viewer, to the position of the principal display region 18. That is to say, in the present embodiment, the virtual edge frame 230 is perceived in an auxiliary display region 234 which is coplanar with the principal display region 18.

Further, the virtual edge frame 230 is perceived to be moved with a varying position of the principal virtual image 16 at which the viewer perceives. This RSD therefore allows the viewer, when attempts to bring the principal virtual image 16 into focus, to concurrently bring the virtual edge frame 230 into focus, following that the viewer perceives the virtual edge frame 230 as a sharp, in focus image, irrespective of movements of the perceived principal virtual image 16.

On the other hand, while the light occluding element 232 is disposed to be perceived as an out of focus image by the viewer who attempts to focus the principal virtual image 16, the border area of the real image of the light occluding element 232 is perceived by the same viewer along with the virtual edge frame 230.

Moreover, it is evident from the above description that the virtual edge frame 230 is always perceived by the viewer as an in focus image or a sharp image. In addition, the virtual edge frame 230 is perceived with a luminance not lower than that of the real world view.

Therefore, in the present embodiment, the physical existence of the light occluding element 232 avoids the real background view from being overlaid onto the principal virtual image 16. A peripheral area of the light occluding element 232, although it is originally perceived as a fuzzy image by the viewer who has focused the principal virtual image 16, is masked by the virtual edge frame 230 perceived as a sharp image at the same distance as the principal virtual image 16 is perceived.

This makes the above peripheral area of the light occluding element 232 to be invisible, allowing the viewer to clearly view the edged principal virtual image 16.

In the fourth embodiment, if the RSD produces a relative movement to the edge frame 210 and the screen 212, then necessary signal processing is required for tracking the edge frame 210 and the screen 212.

In contrast, the RSD according to the present embodiment cannot produce any relative movement to the virtual edge frame 230 (although it is variable in position, presupposed that the aforementioned principal viewing distance is kept unchanged, for the convenience of explanation) and the screen 212 (fixed in position). This does not make it essential to perform the tracking as described above.

The presentation of the virtual edge frame 230 as described above, in the present embodiment, requires the computer 160 to execute an image display program which is in common to the program shown in FIG. 5 except that the original auxiliary-virtual-image data is defined, in the present embodiment, as data for forming the virtual edge frame 230 at the principal viewing distance having a standard value.

As will be evident from the above description, in the present embodiment, the virtual edge frame 230 constitutes an example of the “virtual edge frame” set forth in the above mode (13) or (16), a portion of the signal processing circuit 60 which is assigned to execute the aforementioned image display program constitutes an example of the “virtual-edge-frame generator” set forth in the above mode (13) or (14), and a portion of the signal processing circuit 60 which is assigned to implement the steps corresponding to the steps S2, S4, and S5 shown in FIG. 5 constitutes an example of the “variable generator” set forth in the above mode (15).

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An apparatus for projecting modulated light onto a retina of a viewer, to thereby allow the viewer to perceive a display object via a virtual image, the apparatus comprising:
an emitter emitting light;
a modulator modulating the light; and
a controller controlling the emitter and the modulator for generating virtual images to be perceived by the viewer in an image display field, such that a principal virtual image defining the display object is perceived by the viewer in a principal display region of the image display field, and such that an auxiliary virtual image is perceived by the viewer together with the principal virtual image, in an auxiliary display region which is located in the image display field in a predetermined positional relationship with the principal display region, as viewed from the viewer.

2. The apparatus according to claim 1, wherein the controller includes a cueing block cueing the viewer with the auxiliary virtual image, to promote perception by the viewer of at least one attribute of the display object, the at least one attribute being defined to include at least one of an absolute size of the display object and a distance of the display object from the viewer.

3. The apparatus according to claim 1, wherein the modulator includes a wavefront-curvature modulating block modulating a curvature of a wavefront of the light, and wherein the controller controls the wavefront-curvature modulating block to generate the auxiliary virtual image optionally together with the principal virtual image.

4. The apparatus according to claim 3, wherein the controller controls the wavefront-curvature modulating block to form three-dimensionally the auxiliary virtual image optionally together with the principal virtual image, and wherein the auxiliary virtual image is formed so as to extend from a position of the principal display region toward the viewer along a viewing direction in which the viewer is looking.

5. The apparatus according to claim 4, wherein the controller operates to generate the auxiliary virtual image in the form of selected at least one of:
(a) a perspective linear pattern formed so as to extend from the position of the principal display region toward the viewer along the viewing direction;
(b) a texture density gradient pattern formed so as to extend from the position of the principal display region toward the viewer along the viewing direction, such that local densities of texture of the texture density gradient pattern are varied with corresponding respective distances from the viewer along the viewing direction;
(c) a gradation pattern formed so as to extend from the position of the principal display region toward the viewer along the viewing direction, such that local luminances of the gradation pattern are varied with corresponding respective distances from the viewer along the viewing direction; and
(d) an array of a plurality of separate virtual features disposed along the viewing direction over an area extending from the position of the principal display region toward the viewer, such that the plurality of separate virtual features are varied in size with corresponding respective distances from the viewer along the viewing direction.

6. The apparatus according to claim 1, wherein the controller includes a variable generator generating the auxiliary virtual image, such that the auxiliary virtual image is modified as a function of a value indicative of at least one attribute of the display object, the at least one attribute being defined to include at least one of an absolute size of the display object and a distance of the display object from the viewer.

7. The apparatus according to claim 6, wherein the modulator includes a wavefront-curvature modulating block modulating a curvature of a wavefront of the light, wherein the controller controls the wavefront-curvature modulating block to form three-dimensionally the auxiliary virtual image optionally together with the principal virtual image, wherein the auxiliary virtual image is formed so as to extend from a position of the principal display region toward the viewer along a viewing direction in which the viewer is looking, and wherein the variable generator includes a first generator generating the auxiliary virtual image, such that an entirety of the auxiliary virtual image is modified as a function of the value indicative of the attribute of the display object.

8. The apparatus according to claim 7, wherein the first generator generates the auxiliary virtual image in the form of selected at least one of:
(a) a perspective linear pattern formed so as to extend from the position of the principal display region toward the viewer along the viewing direction, an entirety of the perspective linear pattern being modified as a function of a principal viewing distance between the principal virtual image and the viewer along the viewing direction;
(b) a texture density gradient pattern formed so as to extend from the position of the principal display region toward the viewer along the viewing direction, such that local densities of texture of the texture density gradient pattern are varied with corresponding respective distances from the viewer along the viewing direction, an entirety of the texture density gradient pattern being modified as a function of the principal viewing distance;
(c) a gradation pattern formed so as to extend from the position of the principal display region toward the viewer along the viewing direction, such that local luminances of the gradation pattern are varied with corresponding respective distances from the viewer along the viewing direction, an entirety of the gradation pattern being modified as a function of the principal viewing distance; and
(d) an array of a plurality of separate virtual features disposed along the viewing direction over an area extending from the position of the principal display region toward the viewer, such that the plurality of separate virtual features are varied in size with corresponding respective distances from the viewer along the viewing direction, an entirety of the array being modified as a function of the principal viewing distance.

9. The apparatus according to claim 6, wherein the auxiliary virtual image includes a virtual image of a standardized-in-size object that has a standardized absolute size and that has been commonly known, and wherein the variable generator includes a second generator generating the auxiliary virtual image in the form of the virtual image of the standardized-in-size object.

10. The apparatus according to claim 9, wherein the second generator generates the virtual image of the standardized-in-size object, such that the standardized-in-size object is perceived by the viewer in the proximity to a position at which the principal virtual image is perceived.

11. The apparatus according to claim 9, wherein the standardized-in-size object includes at least one of a playing card, a bill, a coin, and a ball for sport.

12. The apparatus according to claim 1, wherein the auxiliary virtual image is lower in luminance or saturation than the principal virtual image.

13. The apparatus according to claim 1, of a see-through type which allows the viewer to perceive the principal and auxiliary virtual images while viewing a real world scene, the apparatus being used with a light occluding element as a real existence which inhibits entry of ambient light from the real world scene into an eye of the viewer, for avoiding the ambient light from affecting the principal virtual image perceived by the viewer, wherein the auxiliary virtual image includes an image of a virtual edge frame surrounding a periphery of the principal display region, and wherein the controller includes a virtual-edge-frame generator generating the virtual edge frame to be perceived by the viewer in the auxiliary display region.

14. The apparatus according to claim 13, wherein the virtual-edge-frame generator generates the virtual edge frame to be perceived by the viewer at a distance substantially equal to a distance of the principal virtual image from the viewer.

15. The apparatus according to claim 14, wherein the virtual-edge-frame generator includes a variable generator generating the virtual edge frame so as to be perceived by the viewer at a varying distance in accordance with a varying position at which the principal virtual image is perceived by the viewer.

16. The apparatus according to claim 1, of a see-through type which allows the viewer to perceive the principal and auxiliary virtual images while viewing a real world scene, the apparatus being used with a physical edge frame disposed to surround a periphery of the principal display region, and a black-colored physical member for occluding ambient light coming from the real world scene, the physical member being disposed and dimensioned so as to cover the physical edge frame and so as to fill a space defined by and within the physical edge frame, wherein the controller operates to generate the auxiliary virtual image for allowing the viewer to perceive the auxiliary virtual image so as to extend along a viewing direction in which the viewer is looking, and so as to have both ends spaced apart in the viewing direction, a proximal one of which is disposed substantially at the physical edge frame.

17. The apparatus according to claim 13, wherein the virtual edge frame is not less in luminance than the real world scene.

18. The apparatus according to claim 1, wherein the auxiliary virtual image is generated using image data which has been previously stored or is timely produced in the apparatus.

19. The apparatus according to claim 1, wherein the auxiliary virtual image is generated using image data which enters the apparatus from a separate apparatus for processing information.

20. A method of projecting modulated light onto a retina of a viewer, to thereby allow the viewer to perceive a display object via a virtual image, the method comprising the steps of:
generating a principal virtual image defining the display object, to be perceived by the viewer in a principal display region of an image display field; and
generating an auxiliary virtual image to be perceived by the viewer in an auxiliary display region which is located in the image display field in a predetermined positional relationship with the principal display region, as viewed from the viewer.

21. The method according to claim 20, wherein the step of generating the auxiliary virtual image includes a step of cueing the viewer with the auxiliary virtual image, to promote perception by the viewer of at least one attribute of the display object, the at least one attribute being defined to include at least one of an absolute size of the display object and a distance of the display object from the viewer.
